(19) United States
(12) Patent Application Publication
(10) Pub. No.: US 2024/0388034 A1
(43) Pub. Date: Nov. 21, 2024

(54) CABLE SEAL

(71) Applicant: Aptiv Technologies AG, Schaffhausen (CH)

(72) Inventors: Sergio Andres Villarreal Gomez, Saltillo (MX); Roberto Carlos Narro Lara, Saltillo (MX); Eduardo Gilberto Sena Carranza, Saltillo (MX); Peter Thomas Bucco, Cortland, OH (US); William G. Strang, Newton Falls, OH (US)

(21) Appl. No.: 18/664,824

(22) Filed: May 15, 2024

Related U.S. Application Data
(60) Provisional application No. 63/466,753, filed on May 16, 2023.

(51) Int. Cl. H01R 13/52; H01R 13/506

(52) U.S. Cl. CPC H01R 13/5205; H01R 13/506; H01R 13/5216

(57) ABSTRACT

A cable seal assembly includes a cylindrical seal and a seal retainer. The cylindrical seal includes a first inner semi-cylindrical portion having a first cable engagement surface formed along an inner surface of the first inner semi-cylindrical portion. The cylindrical seal includes a second inner semi-cylindrical portion having a second cable engagement surface formed along an inner surface of the second inner semi-cylindrical portion. The seal retainer includes a first retainer half-shell associated with the first inner semi-cylindrical portion and a second retainer half-shell associated with the second inner semi-cylindrical portion. The seal retainer is configured to rotatably close to compress at least a portion of the first inner semi-cylindrical portion and the second inner semi-cylindrical portion between the seal retainer and a cable.

### CROSS-REFERENCE TO RELATED APPLICATIONS

This application claims the benefit of and priority to U.S. provisional application 63/466,753 titled “Hinged Cable Seal”, filed May 16, 2023, the contents of which are incorporated by reference herein.

### TECHNICAL FIELD

The subject matter disclosed herein relates to an electrical seal and, in particular, to a hinged cable seal suitable for use in an electrical connector.

### BACKGROUND

In general, cable seals are used to seal-off cable connectors or terminals from water, dirt, dust, or other debris. For instance, in automotive applications, a cable seal may be used to protect a cable connection from water, weather, dirt, dust, or other debris to preserve the integrity of the electrical connection. A cable seal generally includes a compliant ring seal held by a one-piece seal retainer. A cable is pushed (in a direction parallel to the longitudinal axis of the cable) through the ring seal and connected to a connector or terminal within a connector housing. Cable seals generally require precise dimensional tolerances, as for example, a large cable diameter may over-compress the ring seal against the seal retainer and a small cable diameter may not be properly sealed against the ring seal. Further, the insertion of the cable through the ring seal may generate friction and/or over-compress the ring seal causing damage. Therefore, there is a need for a cable seal adapted for a wider range of cable diameters and/or a cable insertion method that does not degrade the seal.

### SUMMARY

According to one aspect, a cable seal assembly includes a cylindrical seal and a seal retainer. The cylindrical seal includes a first inner semi-cylindrical portion having a first cable engagement surface formed along an inner surface of the first inner semi-cylindrical portion. The cylindrical seal includes a second inner semi-cylindrical portion having a second cable engagement surface formed along an inner surface of the second inner semi-cylindrical portion. The seal retainer includes a first retainer half-shell associated with the first inner semi-cylindrical portion and a second retainer half-shell associated with the second inner semi-cylindrical portion. The seal retainer is configured to rotatably close to compress at least a portion of the first inner semi-cylindrical portion and the second inner semi-cylindrical portion between the seal retainer and a cable.

According to another aspect, a system for sealing a cable connector. The system includes a cable seal and a connector housing. The cable seal includes a seal retainer including a first retainer shell and a second retainer shell. The first retainer shell and the second retainer shell form a retainer aperture. A cylindrical seal extends radially inward from the retainer aperture. The cylindrical seal includes a first semi-cylindrical portion and a second semi-cylindrical portion. The connector housing includes a cavity configured to receive the cylindrical seal of the cable seal therein.

According to some embodiments, a method for sealing a cable connector. A cable seal is provided. The cable seal includes a cylindrical seal having a first semi-cylindrical portion with a first surface and a second semi-cylindrical portion with a second surface. The cable seal includes a seal retainer having a first retainer portion secured to the first semi-cylindrical portion and a second retainer portion secured to the second semi-cylindrical portion. A cable is placed between the first retainer portion and the second retainer portion. The first retainer portion is urged toward the second retainer portion to engage the first surface with the second surface.

### BRIEF DESCRIPTION OF THE DRAWINGS

FIG. 1 is an isometric view of a prior art cable seal assembly.

FIG. 2A is an isometric rear view of a cable seal assembly in an open state, according to some embodiments.

FIG. 2B is an isometric rear view of a cable seal assembly in a closed state, according to some embodiments.

FIG. 2C is an isometric front view of a cable seal assembly in a closed state, according to some embodiments.

FIG. 3A is a partially exploded isometric view of a cable seal assembly and a connector housing, according to some embodiments.

FIG. 3B is an isometric view of a cable seal assembly secured to a connector housing, according to some embodiments.

FIG. 3C is a cross sectional side view of a cable seal assembly secured to a connector housing, according to some embodiments.

FIG. 4 is a flow chart of a method for sealing a cable connector, according to some embodiments.

### DETAILED DESCRIPTION

The present disclosure describes a cable seal assembly configured to seal a cable connector or cable terminal from water, dust, debris, or other contaminants. In some embodiments, the cable seal assembly includes a compliant cable seal co-molded with a rigid seal retainer. The compliant cable seal is configured to engage the cable to form a water-resistance (or watertight) seal and the rigid seal retainer provides structural support for the complaint cable seal to compress against. In some embodiments, the cable seal assembly includes two semi-cylindrical portions-a first portion includes a first semi-cylindrical seal bonded to a first retainer shell and a second portion includes a second semi-cylindrical seal bonded to a second retainer shell. The two semi-cylindrical portions are securable to each other, for instance, via actuation of a hinge positioned therebetween. Thus, the cable seal assembly is securable to the cable without needing to push an end of the cable through the aperture of the seal. Instead, the two semi-cylindrical portions of the cable seal can be placed directly on the body of the cable and secured together with the cable positioned therebetween. Such configuration is beneficial, as terminals and/or connectors positioned at the end of the cable do not need to pass through the cable seal (which could damage the seal). Further, pushing the cable through the aperture of the cable seal generates friction forces which could damage the seal.

In some embodiments, the compliant cable seal includes a plurality of deformable ribs extending circumferential relative to a longitudinal axis of the cable. The plurality of ribs provides a sealing surface for the cable—i.e., the surface of the cable engages a surface of the plurality of ribs to form a seal between the cable and the compliant cable seal. In some embodiments, the plurality of ribs allows a wider range of cable diameters to be sealed by the cable seal assembly (as opposed to a standard ring seal). For instance, the plurality of ribs is able to compress (between the cable and the seal retainer) more than a standard ring seal because the plurality of ribs occupies less total volume (i.e., having gaps between ribs) than a standard ring seal. Thus, the plurality of deformable ribs enables the compliant ring seal to conform to larger cable diameters, and therefore, the cable seal assembly is compatible with a larger range of cable diameters.

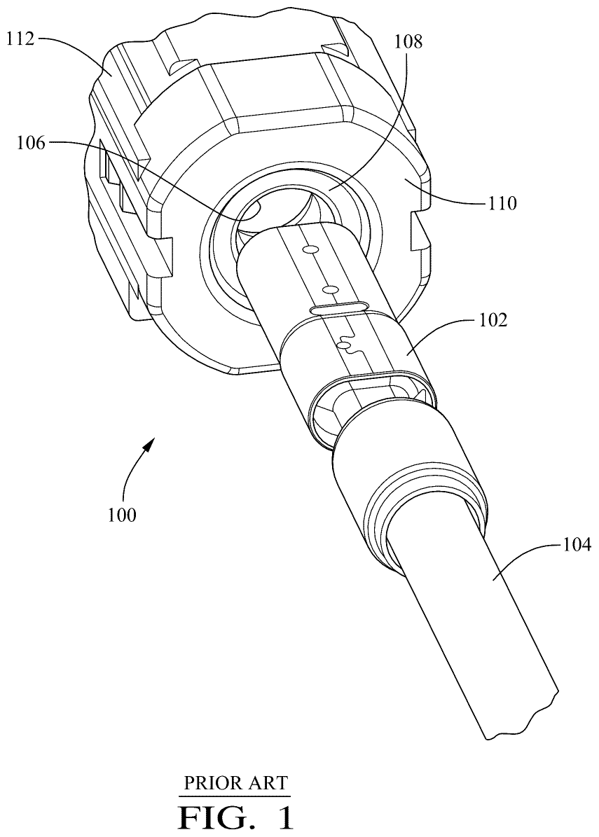

FIG. 1 is an isometric view of a prior art cable seal assembly 100. The prior art cable seal assembly 100 includes a terminal 102, a cable 104, a ring seal 108 having an aperture 106, a seal retainer 110, and a connector housing 112. The cable seal assembly 100 is a single body mold (e.g., the connector housing 112 is formed and the ring seal 108 is moved into place). The terminal 102 is secured to a distal end of the cable 104 and configured to electrically couple a conductive element (not shown) of the cable 104 to an electrical connector (not shown) disposed within the connector housing 112. The terminal 102 and the cable 104 are pushed through the aperture 106 of the ring seal 108. The ring seal 108 is therefore compressed between the terminal 102 and the seal retainer 110. In some cases, if the terminal 102 is too large, the ring seal 108 may be over-compressed as the terminal 102 passes through, causing permanent damage to the ring seal 108. Thus, in many cases, the terminal 102 must be approximately the same size or less than the cable 104 to allow the terminal 102 to pass through the ring seal 108 without causing damage.

In some embodiments, in order to generate a water resistant seal, the aperture 106 of the ring seal 108 must be less than the diameter of the cable 104. However, if the aperture 106 is too small, high friction forces may be generated upon insertion of the cable 104 through the aperture 106, causing tears and/or over-compression of the ring seal 108. Thus, the dimensions of the cable 104, the ring seal 108, and the seal retainer 110 must be manufactured with narrow dimensional tolerances and the cable seal assembly 100 can only be used on a narrow range of cable diameters.

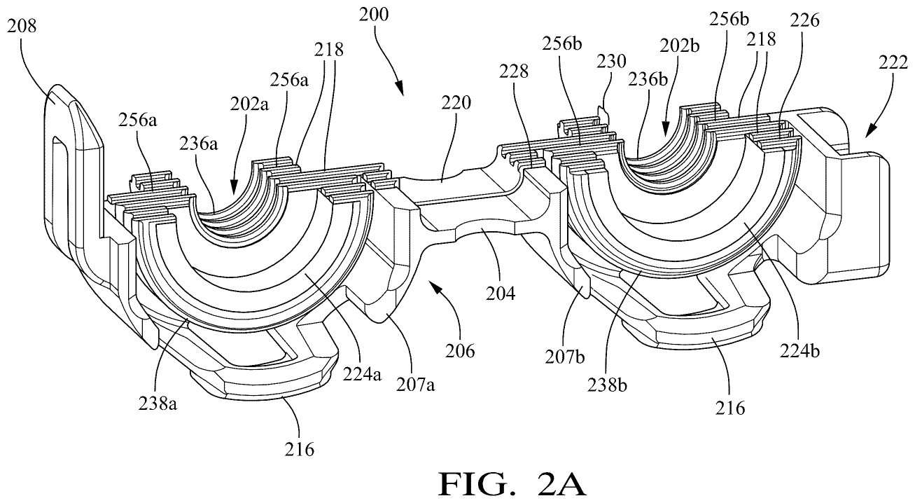

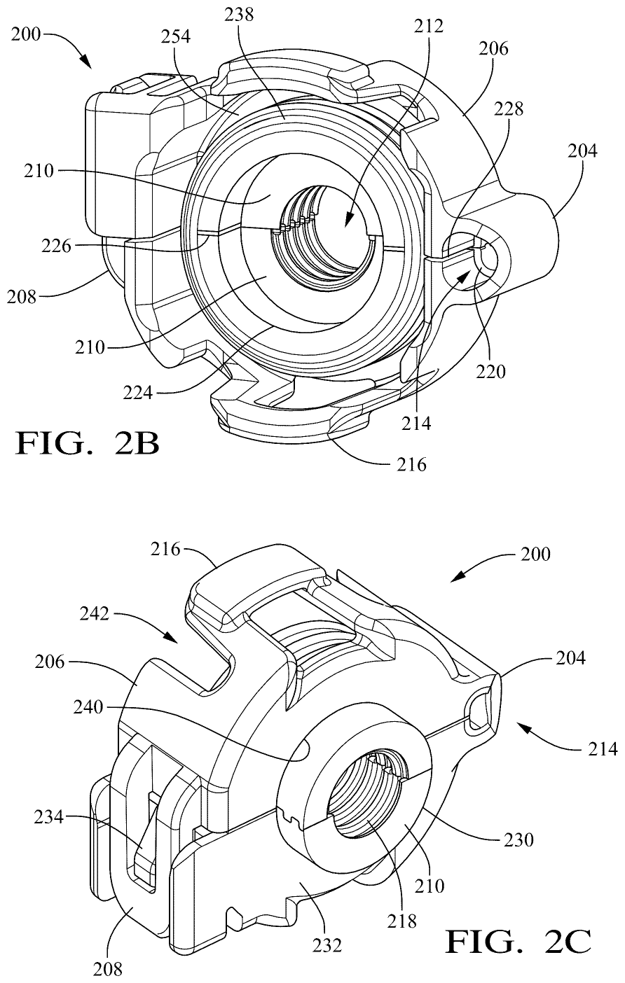

Referring to FIGS. 2A-2C, a cable seal assembly 200 is shown in an open state (FIG. 2A) and a closed state (FIGS. 2B and 2C). In some embodiments, the cable seal assembly 200 includes a seal retainer 206 and a cylindrical seal 210, each bifurcated into first and second halves. The seal retainer 206 includes first and second retainer half-shells 207a, 207b (or first and second retainer shells 207a, 207b) hingedly or rotatably connected to one another by connecting bridge or hinge 204. Each retainer half shell 207a, 207b includes a non-compliant half-ring 224a, 224b (simply the non-compliant ring 224 in the closed state) having an inner surface and an outer surface, an attachment feature 216, and either a latch 208 or a tab 234 for interfacing with the latch 208 when the first and second half-shells 207a, 207b are brought together or closed via hinge 204. In some embodiments, the cylindrical seal 210 is formed around the non-compliant ring 224 such that a rearward portion 226 of the cylindrical seal 210 is positioned on a surface of the non-compliant ring 224 and a connector seal portion 238 (or first and second outer semi-cylindrical portions 238a, 238b) is positioned on the outer surface of the non-compliant ring 224. In some embodiments, the cylindrical seal 210 may define an elliptical shape. In other embodiments, the first and second half-shells 207a, 207b may form other shapes, including for example, oval and/or rectangular profiles.

In some embodiments, the cylindrical seal 210 may be positioned on various surfaces of the seal retainer 206. For example, the cylindrical seal 210 may include first and second inner semi-cylindrical portions 202a, 202b positioned radially inward of the non-compliant ring 224 associated with the seal retainer 206. The first inner semi-cylindrical portion 202a and the second inner semi-cylindrical portion 202b include first and second surfaces 256a, 256b, respectively, that are brought into contact with one another when closed to form a sealing surface. In addition, the first inner semi-cylindrical portion 202a and the second inner semi-cylindrical portion 202b include first and second cable engagement surfaces 236a. 236b that are brought into contact with a cable when closed to form a sealing surface around the cable. In some embodiments, the cylindrical seal 210 is formed of a compliant material (e.g., clastic material, polymeric material, rubber material) configured to deform upon compression. When the cable seal assembly 200 is closed, a portion of the cylindrical seal 210 (e.g., cable engagement surfaces 236a, 236b) is captured between the cable (not shown) and the non-compliant ring 224, causing the cylindrical seal 210 to deform. In some embodiments, a forward portion 230 of the first and second inner semi-cylindrical portions 202a, 202b is unsupported by the non-compliant ring 224. For example, as shown in FIG. 2C, the forward portion 230 of the first and second inner semi-cylindrical portions 202a, 202b is located forward of the non-compliant ring 224. Being unsupported by the non-compliant ring 224 the forward portion 230 does not provide compression of the cable but does prevent bending or kinking of the cable due to forces experienced by the cable exterior to the cable seal assembly 200.

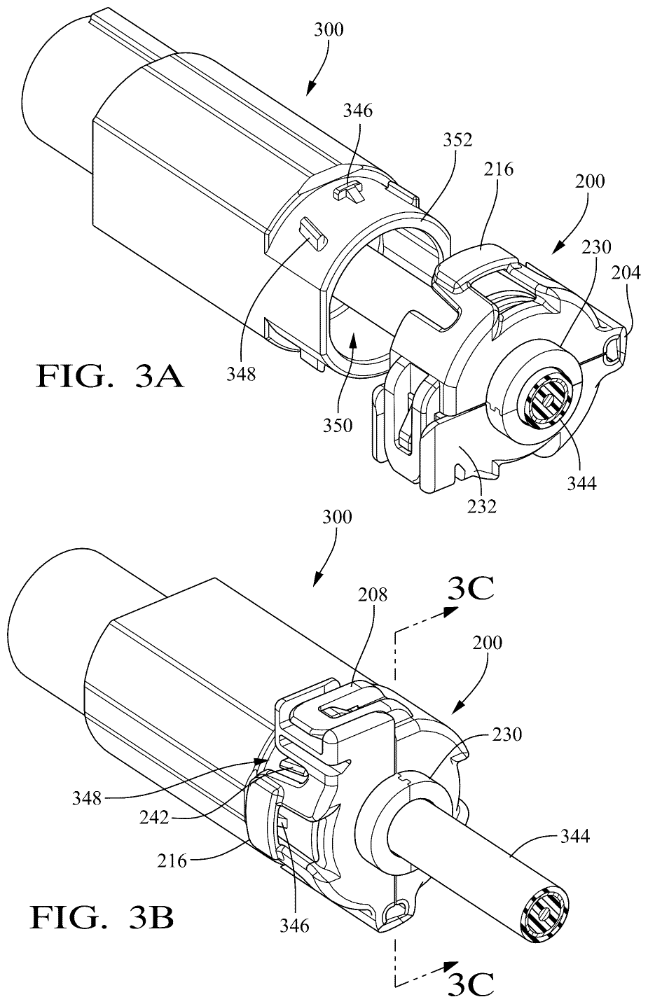

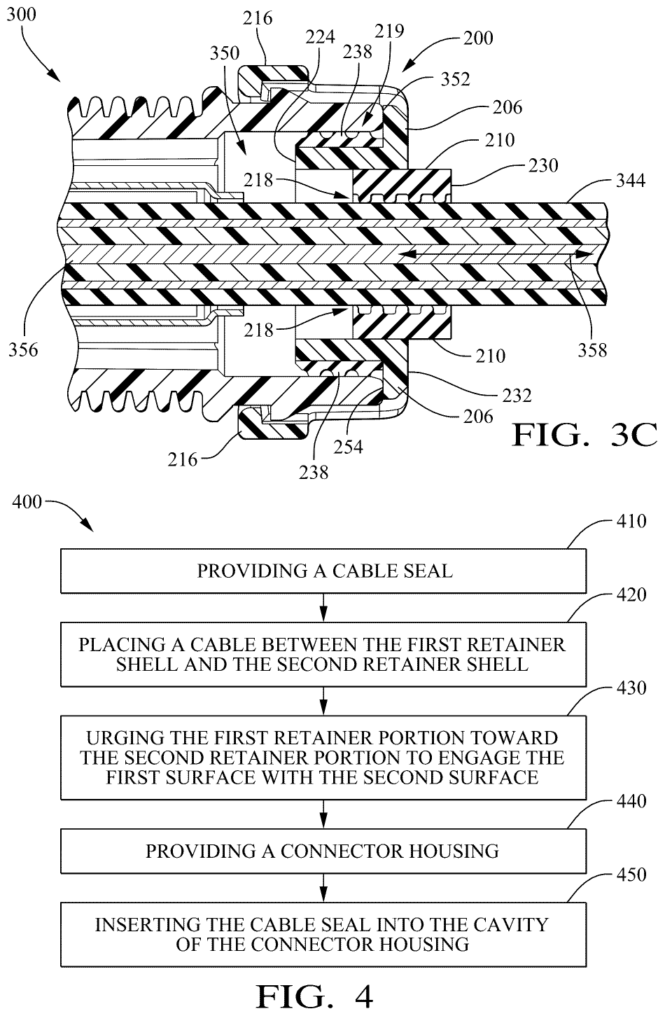

In addition, the cylindrical seal 210 may include first and second outer semi-cylindrical portions 238a, 238b positioned radially outward of the non-compliant ring 224 associated with the seal retainer 206. The first and second outer semi-cylindrical portions 238a, 238b provide a seal between the connector housing 300 (shown in FIGS. 3A-3C) and the cable seal assembly 200.

In some embodiments, the cylindrical seal 210 may utilize a topography (e.g., ribs) that further improves sealing. For example, as shown in FIGS. 2A-2B, the cylindrical seal 210 includes a plurality of ribs 218 extending towards the surface to be sealed. For example, with respect to the first and second inner semi-cylindrical portions 202a, 202b, the plurality of ribs 218 extend radially inward toward the aperture 212. In some embodiments, the aperture 212 includes a substantially circular profile. In other embodiments, the aperture 212 defines an elliptical and/or oval profile. Other shapes of the aperture 212 are possible, for instance, the aperture 212 can be shaped to conform to the cable extending therethrough. For instance, if two cables are configured to extend through the aperture 212 (in a side-to-side orientation), the aperture 212 may be elongated. In some embodiments, the plurality of ribs 218 are a series of channels and/or ridges that repeat along an axial direction of the cable, with each rib of the plurality of ribs 218 extending approximately circumferentially to the longitudinal axis of the cable. The plurality of ribs 218 located on the cable engagement surfaces 236a, 236b extend radially inward from the retainer aperture 240 and engage with and seal the cable in the closed state. In some embodiments, first and second surfaces 256a, 256b also include the plurality of ribs 218 that interact with one another in the closed state. The first surface 256a and the second surface 256b may engage or abut each other to form a seal between the first semi-cylindrical portion 202a and the second semi-cylindrical portion 202b.

In some embodiments, the plurality of ribs 218 on the first semi-cylindrical portion 202a are axially aligned with the plurality of ribs 218 on the second semi-cylindrical portion 202b (i.e., the forwardmost rib of the first semi-cylindrical portion 202a is centered with forwardmost rib of the second semi-cylindrical portion 202b). In other embodiments, the plurality of ribs 218 on the first semi-cylindrical portion 202a are offset from the plurality of ribs 218 on the second semi-cylindrical portion 202b such that a mating connection is formed. In other words, the plurality of ribs 218 on the first semi-cylindrical portion 202a are partially received within the gaps of the plurality of ribs 218 on the second semi-cylindrical portion 202b, and vice-versa.

In some embodiments, the seal retainer 206 is formed of a rigid material having a durometer greater than the cylindrical seal 210. Thus, the seal retainer provides structural support for the cable seal assembly 200 and a structure for the cylindrical seal 210 to compress against when a cable is received within the aperture 212. In some embodiments, the hinge 204 is an integral strap. i.e., the first retainer half-shell 207a, the second retainer half-shell 207b, and the hinge 204 are formed as a one-piece component (e.g., extruded or injection molded as a single construction piece). Such configuration is beneficial, as it reduces the number of components and/or steps needed to assemble the cable seal assembly. In some embodiments, the thickness of the hinge 204 is less than the thickness of the first and second retainer half-shell 207a, 207b to allow the hinge flexibilty to hinge or bend.

In some embodiments, the seal retainer 206 is co-molded (i.e., over-molded) with the cylindrical seal 210. The co-molding or over-molding refers to the rigid material of the seal retainer 206 being bonded with the compliant material of the cylindrical seal 210. For example, the cylindrical seal 210 may be formed of a first material (having a first durometer) and the seal retainer 206 may be formed of a second material (having a second durometer). The two materials may be injected into a single mold—i.e., the second material may be injected first and cooled to form the seal retainer 206, then the first material may be injected to form the cylindrical seal 210. The co-molding of the seal retainer 206 and the cylindrical seal 210 is beneficial because it bonds the cylindrical seal 210 directly to a surface of the seal retainer 206, thereby providing a strong connection between the two components without additional assembly steps (i.e., adhesives, seating the seal within the retainer, etc.). The co-molding also enables the compliant material (first material) to wholly surround features of the seal retainer 206. For instance, the non-compliant ring 224 of the seal retainer 206 may be encapsulated with compliant material (e.g., the compliant material is located on an inner surface of the non-compliant ring 224 and the outer surface of the non-compliant ring 224). Such configuration improves the scaling function of the cable seal assembly 200.

In some embodiments, the cylindrical seal 210 is compressed between a cable and the seal retainer 206 (see e.g., FIGS. 3A-C). Compression of the (compliant) cylindrical seal 210 deforms the plurality of ribs 218 against the surface of the cable, increasing the sealing surface area and increasing the pressure between the plurality of ribs 218 and the cable. For instance, the diameter of the aperture 212 in the cylindrical seal 210 is selected to be less than the diameter of the cable. The cable is placed between the first semi-cylindrical portion 202a and the second semi-cylindrical portion 202b, and the cable assembly is actuated such that the first surface 256a engages the second surface 256b. In some embodiments, the first retainer shell 207a includes a feature (i.e., the latch 208) securable to the second retainer shell 207b (e.g., the channel 222 and/or the tab 234) to provide compression between the first surface 256a and the second surface 256b, forming a seal therebetween. The compression between the first retainer shell 207a and the second retainer shell 207b urges the cylindrical seal 210 toward the cable-however, the surface of the cable engages the cylindrical seal 210 and pressure is generated in the cylindrical seal 210 between the cable and the walls of the seal retainer 206.

The two-portion retainer shell (i.e., the first retainer shell 207a and the second retainer shell 207b) is beneficial, as it enables the cable seal assembly 200 to be secured to the cable without inserting an end of the cable or terminal through the aperture 212. Instead, the first retainer shell 207a (and first semi-cylindrical portion 202a) is placed onto the cable (or vice versa) and the second retainer shell 207b (and second semi-cylindrical portion 202b) is secured to the first retainer shell 207a to sandwich the cable therebetween. Thus, the cable seal assembly 200 can be used with any sized terminal or cable end connector. Further, because the cable does not need to be pushed through the aperture 212 in an axial direction, there is less tension/friction force acting on the cylindrical seal 210 during installation (as compared to the cable seal assembly illustrated in FIG. 1).

The plurality of ribs 218 is beneficial, as it provides a plurality of high-pressure seal points along the axial length of the cylindrical seal 210. Thus, if one of the plurality of ribs 218 is deformed or defective, there are additional high-pressure seal point(s) to prevent water or debris from entering the connector housing. The plurality of ribs 218 increases the available sealing surface area, thereby providing an effective seal. Further, the plurality of ribs 218 are highly deformable (as compared to a solid-body ring seal), as there is empty volume between each of the plurality of rib 218. The empty volume is filled upon compression of the cylindrical seal 210. The high deformity of the plurality of ribs 218 enables the cylindrical seal 210 to receive a wide range of cable diameters.

In some embodiments, the cable is removably secured to the cable seal assembly 200. For instance, the latch 208 on the first retainer shell 207a is disengageable from the tab 234 and/or the channel 222 on the second retainer shell 207b. Thus, the first retainer shell 207a can be separated from the second retainer shell 207b (e.g., via actuation of the hinge 204) to allow the cable positioned therebetween to be removed from the cable seal assembly 200. Such configuration is beneficial, as it allows for maintenance of the cable seal assembly 200 and/or the cable without damaging any of the components. In contrast to the cable seal assembly 200, removal of the cable 104 from the cable seal assembly 100 illustrated in FIG. 1 requires the cable 104 to be pulled along its longitudinal axis out from the aperture 106 of the ring seal 108. Pulling the cable 104 (and the cable end/terminal) out from the ring seal 108 may cause over-compression or tearing of the ring seal, thereby requiring the cable seal assembly 100 to be replaced.

FIG. 3A is a partially exploded isometric view of a cable seal assembly 200 and a connector housing 300, according to some embodiments. The connector housing 300 includes a locking tab 346, an alignment tab 348, a cavity 350, and a connector face 352. A cable 344 is received by the cable seal assembly 200 and the connector housing 300, the cable 344 includes a terminal 356 and a longitudinal axis 358 extending along the axial direction. In some embodiments, the cable seal assembly 200 is configured to receive more than one cable through the aperture 212. For example, two cables may be received through the aperture 212, or alternatively, four cables may be received through the aperture 212. In some embodiments, the shape of the aperture 212 can be selected to reflect the shape of the one or more cables extending therethrough. FIG. 3B is an isometric view of the cable seal assembly 200 secured to the connector housing 300, according to some embodiments.

In some embodiments, the cable seal assembly 200 is securable to the connector housing 300. For instance, the attachment feature 216 of the seal retainer 206 is securable to the locking tab 346 of the connector housing 300. The locking tab 346 guarantees that the cable seal assembly 200 is properly attached (i.e., secured and sealed) to the connector housing 300. The alignment tab 348 is positioned to align with the alignment channel 242 of the cable seal assembly 200. The alignment tab 348 ensures the proper alignment of the locking tab 346 with the attachment feature 216 and/or alignment of other features of the cable seal assembly 200 and the connector housing 300.

In some embodiments, the cable seal assembly 200 is removably securable to the connector housing. For instance, the attachment feature 216 is disengageable from the locking tabs 346 to allow removal of the cable seal assembly 200 from the connector housing 300. Such configuration is beneficial, as it allows for maintenance of the cable seal assembly 200 and/or the connector housing 300 without replacing both components.

FIG. 3C is a cross sectional side view of the cable seal assembly 200 secured to the connector housing 300 and the cable 344, according to some embodiments. The cable seal assembly 200 is at least partially received within the cavity 350 of the connector housing 300. The connector face 352 defines the opening of the cavity 350, and in some embodiments, the connector face 352 abuts the inner stop surface 254 of the seal retainer 206. The cylindrical seal 210, the seal retainer 206, and the connector seal portion 238 are at least partially received within the cavity 350 of the connector housing 300.

In some embodiments, the connector seal portion 238 includes the outer ribs 219 to engage a surface of the connector housing 300. The outer ribs 219 form a sealing connection with an inner surface of the cavity 350 of the connector housing 300, according to some embodiments. The non-compliant ring 224 of the seal retainer 206 provides structural support for the connector seal portion 238, i.e., the connector seal portion 238 is compressed between the non-compliant ring 224 and a surface of the connector housing 300. In some embodiments, the non-compliant ring 224 is a cylindrical side wall of the seal retainer 206 separating the cylindrical seal 210 from the connector seal portion 238. In some embodiments, the cylindrical seal 210 is coupled to the connector seal portion 238 via the first surface 256a and/or the second surface 256b (see e.g., FIG. 2A).

FIG. 4 is a flow chart of a method 400 for sealing a cable connector, according to some embodiments. At step 410, the method 400 includes providing a cable seal. The cable seal includes any and/or all features of the cable seal assembly 200 illustrated in FIGS. 2A-3C. The cable seal assembly 200 includes the first retainer shell 207a coupled to the first semi-cylindrical portion 202a of the cylindrical seal 210 and the second retainer shell 207b coupled to the second semi-cylindrical portion 202b of the cylindrical seal 210.

At step 420, the method 400 includes placing a cable between the first retainer shell 207a and the second retainer shell 207b. The cable includes any and/or all features of the cable(s) referenced above in FIGS. 2A-3C. The cable is placed between the first retainer shell 207a and the second retainer shell 207b such that the terminal (or cable end) is not longitudinally aligned with the seal retainer, according to some embodiments.

At step 430, the method 400 includes urging the first retainer shell 207a toward the second retainer shell 207b to engage the first surface 256a of the first inner semi-cylindrical portion 202a with the second surface 256b of the second inner semi-cylindrical portion 202b. In some embodiments, the hinge 204 is actuated to urge the first retainer shell 207a toward the second retainer shell 207b. The first retainer shell 207a and/or the second retainer shell 207b may include locking elements (e.g., the latch 208, the channel 222, the tab 234, etc.) to secure the first retainer shell 207a to the second retainer shell 207b. In some embodiments, a pressure is generated between the first surface 256a and the second surface 256b to form a seal therebetween.

In some embodiments, urging the first retainer shell 207a toward the second retainer shell 207b provides a seal for the cable. For instance, the plurality of ribs 218 of the first semi-cylindrical portion 202a engage the cable on one side, and the plurality of ribs of the second semi-cylindrical portion 202b engage the cable on another side to form a complete seal around the circumference of the cable. Urging the first retainer shell 207a toward the second retainer shell 207b may compress the cylindrical seal 210 between the cable and the seal retainer 206.

At step 440, the method 400 includes providing a connector housing. The connector housing includes any and/or all features of the connector housing 300 illustrated in FIGS. 3A-C. The connector housing 300 may include an electrical connector port/terminal to electrically couple to the cable.

At step 450, the method 400 includes inserting the cable seal assembly 200 into the cavity 350 of the connector housing 300. The cylindrical seal 210, the seal retainer 206, and the connector seal portion 238 are at least partially received within the cavity 350 of the connector housing 300, according to some embodiments. The cable seal assembly 200 is removably securable to the connector housing 300, for instance, via engagement of the attachment feature 216 with the locking tab 346.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention.

According to one aspect, a cable seal assembly includes a cylindrical seal and a seal retainer. The cylindrical seal includes a first inner semi-cylindrical portion having a first cable engagement surface formed along an inner surface of the first inner semi-cylindrical portion. The cylindrical seal includes a second inner semi-cylindrical portion having a second cable engagement surface formed along an inner surface of the second inner semi-cylindrical portion. The seal retainer includes a first retainer half-shell associated with the first inner semi-cylindrical portion and a second retainer half-shell associated with the second inner semi-cylindrical portion. The seal retainer is configured to rotatably close to compress at least a portion of the first inner semi-cylindrical portion and the second inner semi-cylindrical portion between the seal retainer and a cable.

The cable seal assembly of the preceding paragraph can optionally include, additionally and/or alternatively any, one or more of the following features/steps, configurations and/or additional components.

For example, the first retainer half-shell may be hingedly connected to the second retainer half-shell. The cable seal assembly may further include the cylindrical seal co-molded to the seal retainer. The cylindrical seal may be formed of a compliant material having a first durometer and the seal retainer is formed of a plastic having a second durometer, wherein the second durometer is greater than the first durometer. The cylindrical seal may include a plurality of outer ribs configured to engage a connector housing. The seal retainer may include a non-compliant ring positioned between an engagement surface of the plurality of inner rings and the plurality of outer rings. The first semi-cylindrical portion may include a first plurality of ribs and the second semi-cylindrical portion includes a second plurality of ribs, wherein the first plurality of ribs forms a mating connection with the second plurality of ribs. The first retainer portion may be secured to the second retainer portion via a hinge, wherein actuation of the hinge urges the first retainer portion toward the second retainer portion to engage the first semi-cylindrical portion with the second semi-cylindrical portion.

According to another aspect, a system for sealing a cable connector. The system includes a cable seal and a connector housing. The cable seal includes a seal retainer including a first retainer shell and a second retainer shell. The first retainer shell and the second retainer shell form a retainer aperture. A cylindrical seal extends radially inward from the retainer aperture. The cylindrical seal includes a first semi-cylindrical portion and a second semi-cylindrical portion. The connector housing includes a cavity configured to receive the cylindrical seal of the cable seal therein.

The system for sealing a cable connector of the preceding paragraph can optionally include, additionally and/or alternatively any, one or more of the following features/steps, configurations and/or additional components.

For example, the system for sealing a cable connector may further include an aperture formed by the first semi-cylindrical portion and the second semi-cylindrical portion of the cylindrical seal. A cable can be positioned between the first semi-cylindrical portion and the second semi-cylindrical portion and within the aperture. The cylindrical seal may include a plurality of ribs having an engagement surface configured to engage the cable. In some embodiments, securing the first retainer shell to the second retainer shell provides a clamping force to urge the plurality of ribs toward the cable. The connector housing may include a locking tab and the seal retainer may include an attachment feature. The cable seal may be secured to the connector housing via the attachment feature engaging the locking tab. The cylindrical seal may include an outer seal portion to engage an inner surface of the connector housing. The connector housing may include a connector face configured to engage an inner stop surface of the cable seal. The seal retainer may include a forward end and the cylindrical seal may extend forward of the forward end of the seal retainer.

According to another aspect, a method for sealing a cable connector. A cable seal is provided. The cable seal includes a cylindrical seal having a first semi-cylindrical portion with a first surface and a second semi-cylindrical portion with a second surface. The cable seal includes a seal retainer having a first retainer portion secured to the first semi-cylindrical portion and a second retainer portion secured to the second semi-cylindrical portion. A cable is placed between the first retainer portion and the second retainer portion. The first retainer portion is urged toward the second retainer portion to engage the first surface with the second surface.

The method for sealing a cable connector of the preceding paragraph can optionally include, additionally and/or alternatively any, one or more of the following features/steps, configurations and/or additional components.

For example, the method for sealing a cable connector may include engaging a latch on the first retainer portion with a channel on the second retainer portion to lock the first retainer portion to the second retainer portion. A connector housing may be provided. The cable seal may be inserted into a cavity of the connector housing. The cylindrical seal may include an outer seal portion to engage an inner surface of the connector housing. The seal retainer may include an attachment feature and the connection housing may include a locking tab. Inserting the cable seal into the cavity of the connector housing secures the attachment feature to the locking tab to lock the cable seal to the connector housing. The first retainer portion and the second retainer portion may be placed on the cable at an angle orthogonal to a longitudinal axis of the cable.

1. A cable seal assembly, comprising:
a cylindrical seal including:
a first inner semi-cylindrical portion having a first cable engagement surface formed along a first inner surface of the first inner semi-cylindrical portion, and
a second inner semi-cylindrical portion having a second cable engagement surface formed along a second inner surface of the second inner semi-cylindrical portion; and
a seal retainer including a first retainer half-shell associated with the first inner semi-cylindrical portion and a second retainer half-shell associated with the second inner semi-cylindrical portion, the seal retainer configured to rotatably close to compress at least a portion of the first inner semi-cylindrical portion and the second inner semi-cylindrical portion between the seal retainer and a cable.

2. The cable seal assembly of claim 1, wherein the first retainer half-shell is hingedly connected to the second retainer half-shell.

3. The cable seal assembly of claim 1, wherein the cylindrical seal is co-molded with the seal retainer, the cylindrical seal formed of a first material having a first durometer and the seal retainer formed of a second material having a second durometer, the second durometer is greater than the first durometer.

4. The cable seal assembly of claim 1, wherein the cylindrical seal includes a plurality of inner ribs configured to deform against the cable.

5. The cable seal assembly of claim 4, wherein the cylindrical seal includes first and second outer semi-cylindrical portions positioned on an outer surface of the seal retainer to engage with an inner surface of a connector housing.

6. The cable seal assembly of claim 5, wherein the first and second outer semi-cylindrical portions include a plurality of outer ribs and wherein the seal retainer includes a non-compliant ring positioned between the plurality of inner ribs and the plurality of outer ribs.

7. The cable seal assembly of claim 1, wherein the first retainer half-shell is secured to the second retainer half-shell via a hinge, wherein actuation of the hinge urges the first retainer half-shell toward the second retainer half-shell to engage the first inner semi-cylindrical portion with the second inner semi-cylindrical portion.

8. A system for sealing a cable connector, the system comprising:
a cable seal, including:
a seal retainer including a first retainer shell and a second retainer shell, the first retainer shell and the second retainer shell forming a retainer aperture, and
a cylindrical seal extending radially inward from the retainer aperture, the cylindrical seal including a first semi-cylindrical portion and a second semi-cylindrical portion; and
a connector housing including a cavity configured to receive the cylindrical seal of the cable seal therein.

9. The system of claim 8, wherein the first semi-cylindrical portion and the second semi-cylindrical portion of the cylindrical seal form a seal aperture, wherein a cable is positioned between the first semi-cylindrical portion and the second semi-cylindrical portion and within the seal aperture.

10. The system of claim 8, wherein the cylindrical seal includes a plurality of ribs having an engagement surface configured to deform against a cable.

11. The system of claim 10, wherein securing the first retainer shell to the second retainer shell provides a clamping force to urge the plurality of ribs toward the cable.

12. The system of claim 8, wherein the connector housing includes a locking tab and wherein the seal retainer includes an attachment feature, wherein the cable seal is secured to the connector housing via the attachment feature engaging the locking tab.

13. The system of claim 8, wherein the cylindrical seal includes an outer seal portion to engage an inner surface of the connector housing.

14. The system of claim 8, wherein the seal retainer is configured to rotatably close to compress at least a portion of the first semi-cylindrical portion and the second semi-cylindrical portion between the seal retainer and a cable.

15. The system of claim 8, wherein the seal retainer includes a forward end, wherein the cylindrical seal extends forward of the forward end of the seal retainer.

16. A method for sealing a cable connector, the method comprising:
providing a cable seal, including:
a cylindrical seal having a first semi-cylindrical portion with a first engagement surface and a second semi-cylindrical portion with a second engagement surface, and
a seal retainer having a first retainer portion secured to the first semi-cylindrical portion and a second retainer portion secured to the second semi-cylindrical portion;
placing a cable between the first retainer portion and the second retainer portion; and
urging the first retainer portion toward the second retainer portion to engage the first engagement surface with the second engagement surface.

17. The method of claim 16, wherein urging the first retainer portion toward the second retainer portion includes engaging a latch on the first retainer portion with a channel on the second retainer portion to lock the first retainer portion to the second retainer portion.

18. The method of claim 16 further comprising:
providing a connector housing including a cavity; and
inserting the cable seal into the cavity of the connector housing,
wherein the cylindrical seal includes an outer seal portion to engage an inner surface of the connector housing.

19. The method of claim 18, wherein the seal retainer includes an attachment feature and the connector housing includes a locking tab, wherein inserting the cable seal into the cavity of the connector housing secures the attachment feature to the locking tab to lock the cable seal to the connector housing.

20. The method of claim 16, wherein the first retainer portion and the second retainer portion are placed on the cable at an angle orthogonal to a longitudinal axis of the cable.
